(19) United States
(12) Patent Application Publication
(10) Pub. No.: US 2022/0011476 A1
(43) Pub. Date: Jan. 13, 2022

(54) THIN FILM TYPE OF APERTURE FOR IMAGE LENS

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 17/095,624

(22) Filed: Nov. 11, 2020

(30) Foreign Application Priority Data
Jul. 8, 2020 (CN) 202010653828.2

(51) Int. Cl. G02B 5/00; G02B 7/02

(52) U.S. Cl. CPC G02B 5/005; G02B 7/021

(57) ABSTRACT

An optical lens includes a lens barrel, a first lens, and an aperture. The lens barrel includes a first end and a second end. A receiving space is provided between the first end and the second end. The first end is provided with a light inlet opening communicating with the receiving space. The second end is provided with a light outlet opening communicating with the receiving space. A first light enters through the light inlet opening. A second light exits through the light outlet opening. The first lens is located in the receiving space and configured to receive and transmit at least a portion of the first light. The aperture is located in the receiving space and fixedly arranged on a side of the first lens facing away from the second end. The aperture is used to adjust an amount of the first light incident into the lens barrel.

### FIELD

The subject matter herein generally relates to optical lenses, and more particularly to an optical lens of an electronic device.

### BACKGROUND

A lens module includes an aperture and a lens group. Generally, a large distance between the aperture and the lens group may exist, which is not conducive for improving alignment accuracy between the aperture and the lens group. The lens module includes a lens barrel with a receiving space for receiving the lens group. The aperture is directly adhered to an outer surface of the lens barrel by glue. Since the aperture and the lens barrel are not transparent, the glue cannot be cured by ultraviolet light. Therefore, the glue is usually cured by a thermal curing method, which process is not only time-consuming, but also causes a relative position between the aperture and the lens group to shift.

### BRIEF DESCRIPTION OF THE DRAWINGS

Implementations of the present disclosure will now be described, by way of embodiments, with reference to the attached figures.

FIG. 1 is a schematic perspective diagram of an electronic device according to an embodiment of the present disclosure.

FIG. 2 is a schematic cross-sectional diagram of an optical lens of the electronic device in FIG. 1.

FIG. 3 is an enlarged schematic diagram of circled portion III in FIG. 2.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

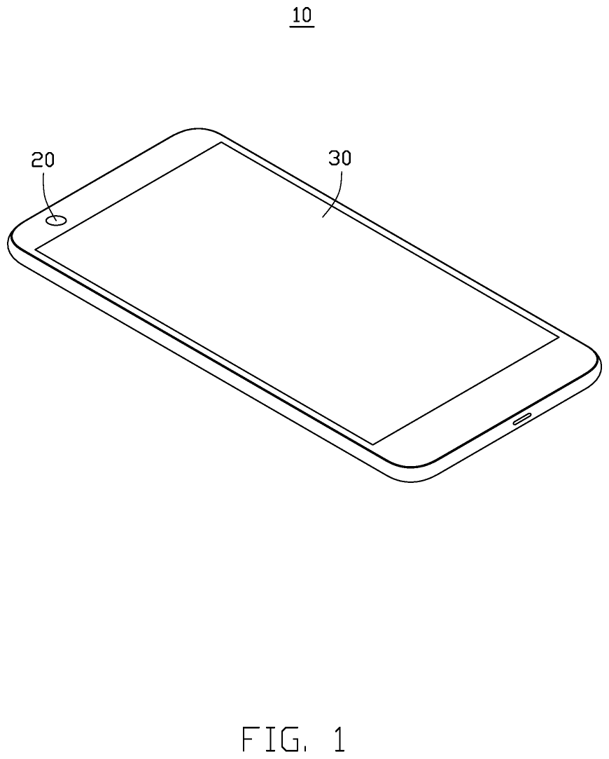

FIG. 1 shows an embodiment of an electronic device 10. The electronic device 10 may be a smart phone with an image shooting function. In other embodiments, the electronic device 10 may be other types of electronic devices with image shooting functions, such as a tablet computer.

The electronic device 10 includes an optical lens 20 and a display panel 30. The optical lens 20 is used for receiving a first light (and emitting a second light according to the first light. The first light is the ambient light of the environment in which the electronic device 10 is located. The display panel 30 is coupled to the optical lens 20. In one embodiment, the display panel 30 is coupled to the optical lens 20 through a photoelectric conversion device (not shown). The photoelectric conversion device may be an image sensor. The image sensor can generate image signals according to the second light, and the display panel 30 is used to display an image according to the image signals.

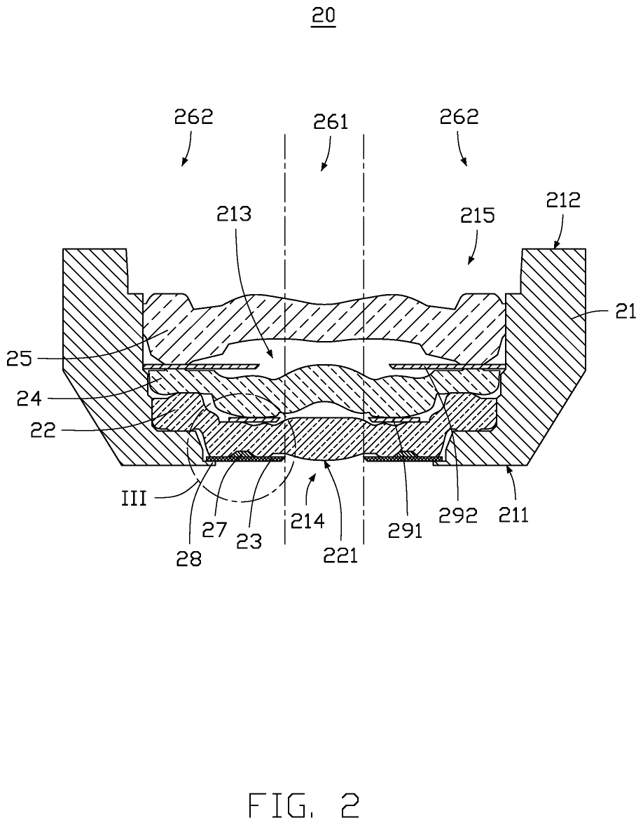

Referring to FIG. 2, the optical lens 20 includes a lens barrel 21. The lens barrel 21 is made of an opaque material. The lens barrel 21 has a substantially cylindrical shape. The lens barrel 21 has a first end 211 and a second end 212. The second end 212 is opposite to the first end 211. A receiving space 213 is defined between the first end 211 and the second end 212. The first end 211 is provided with a light inlet opening 214. The second end 212 is provided with a light outlet opening 215. The first light enters the optical lens 20 through the light inlet opening 214, and the second light exits the optical lens 20 through the light outlet opening 215.

The optical lens 20 further includes a first lens 22. The first lens 22 has light transmittance. The first lens 22 is received in the receiving space 213. The first lens 22 is used to receive and at least partially transmit the first light.

The optical lens 20 is further provided with an aperture 23 located in the receiving space 213. The first lens 22 has a surface 221, and the aperture 23 is fixedly arranged on the surface 221 of the first lens 22. In one embodiment, the aperture 23 is fixed on the surface 221 of the first lens 22 by an adhesive.

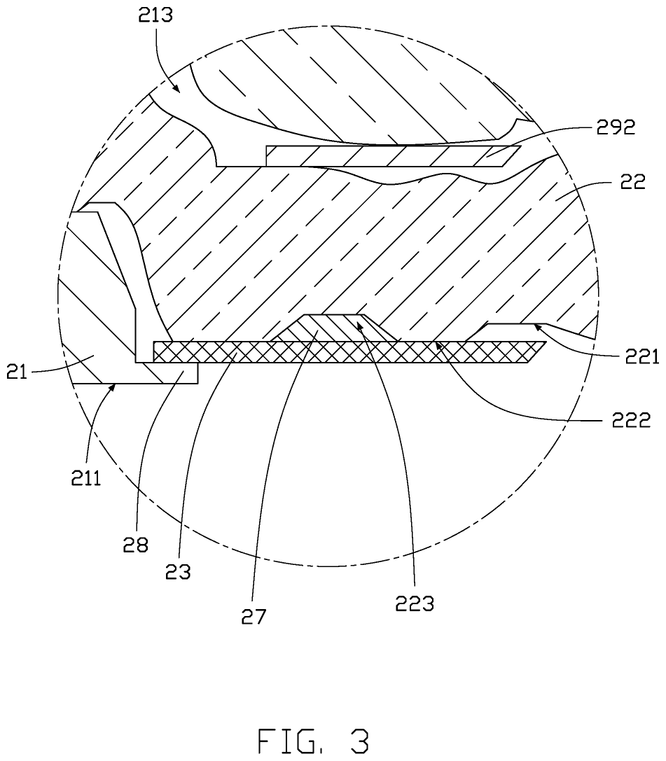

Referring to FIG. 3, the surface 221 of the first lens 22 has a bonding area 222. The bonding area 222 is used to directly bond with the aperture 23. In one embodiment, the aperture 23 has an annular structure, and the bonding area 222 has an annular area. The bonding area 222 is provided with a groove 223. The groove 223 is used to accommodate an adhesive 27. The adhesive 27 is used to fix the aperture 23 and the first lens 22 together. In one embodiment, the groove 223 is an annular groove, which is beneficial to enhance a fixing strength between the aperture 23 and the first lens 22. In other embodiments, the groove 223 can be other shapes and be multiple grooves.

Further referring to FIG. 2, in one embodiment, the adhesive 27 is completely contained in the groove 223, so that a surface of the adhesive 27 filled in the groove 223 adjacent to the aperture 23 is coplanar with a surface of the bonding area 222 of the first lens 22 adjacent to the aperture 23, so that the bonding area 222 is closely attached to the aperture 23. Thus, a distance between the aperture 23 and the first lens 22 is greatly reduced.

In one embodiment, a line between an optical center of the first lens 22 and a center of the aperture 23 is perpendicular to a plane in which the aperture 23 is located. The above-mentioned structure of the adhesive 27 tightly bonding the aperture 23 and the bonding area 222 greatly reduces a distance between the aperture 23 and the first lens 22, which is beneficial to satisfy alignment accuracy requirements between the aperture 23 and the first lens 22, and thus is beneficial to improve an imaging quality of the optical lens 20. In addition, the aperture 23 is received in the receiving space 213, which is beneficial to reduce an overall thickness of the optical lens 20 (a distance between the first end 211 and the second end 212).

In one embodiment, the adhesive 27 is formed by solidification of liquid glue. The aperture 23 and the first lens 22 are fixedly bonded by the adhesive 27 and then assembled to the lens barrel 21. Since the first lens 22 has light transmittance, the liquid glue can be quickly cured by ultraviolet light from one side of the first lens 22, and an alignment between the aperture 23 and the first lens 22 is not caused to shift.

Referring to FIGS. 2 and 3 together, in one embodiment, the optical lens 20 further includes a carrying portion 28 extending from the first end 211 to the light inlet opening 214. In one embodiment, the carrying portion 28 has a circular ring structure. The light inlet opening 214 is defined as a central circular opening of the carrying portion 28. The aperture 23 is located between the first lens 22 and the carrying portion 28. The carrying portion 28 is used to support the aperture 23 to improve a fixing strength between the aperture 23 and the first lens 22, thereby preventing the aperture 23 from falling off the first lens 22 and preventing the aperture 23 from shifting relative to the first lens 22.

In one embodiment, the optical lens 20 further includes a second lens 24 and a third lens 25. Both the second lens 24 and the third lens 25 are located in the receiving space 213. The aperture 23, the first lens 22, the second lens 24, and the third lens 25 are sequentially arranged in the receiving space 213 along a direction from the first end 211 to the second end 212. Optical centers of the aperture 23, the first lens 22, the second lens 24, and the third lens 25 are on a straight line.

The first lens 22, the second lens 24, and the third lens 25 form an optical path system that focuses at least part of the first light to emit the second light, and the second light is used for imaging. In other embodiments, the optical lens 20 may have more lenses than those described in the present disclosure.

Referring to FIG. 2, each of the first lens 22, the second lens 24, and the third lens 25 includes a light transmission area 261 and a flange area 262. The flange area 262 surrounds the light transmission area 261. The light transmission areas 261 of the first lens 22, the second lens 24, and the third lens 25 are used to focus light for imaging, and the flange areas 262 of the first lens 22, the second lens 24, and the third lens 25 are used for aligning the first lens 22, the second lens 24, and the third lens 25 with each other and fixing to the lens barrel 21.

In one embodiment, at least one alignment mark (not shown) can be provided in the flange area 262 to improve alignment accuracy between the first lens 22 and the aperture 23. In one embodiment, the alignment mark is a ring. The alignment mark may emit light. In the process of assembling the first lens 22, the alignment mark is irradiated with light, and a black and white image can be obtained by detecting the alignment mark by an optical detector. The present disclosure does not limit the shape and number of the alignment mark.

In one embodiment, the aperture 23 has an annular shape and is provided corresponding to the flange areas 262. That is, an orthographic projection of the aperture 23 on the first lens 22, the second lens 24, and the third lens 25 is located in the flange areas 262. The bonding area 222 is also located corresponding to the flange areas 262.

Referring to FIG. 2, in one embodiment, the optical lens 20 further includes a first shielding portion 291 and a second shielding portion 292. Both the first shielding portion 291 and the second shielding portion 292 are annular and located corresponding to the flange areas 262. That is, orthographic projections of the first shielding portion 291 and the second shielding portion 292 on the first lens 22, the second lens 24, and the third lens 25 are located in the flange areas 262. The first shielding portion 291 is located between the second lens 24 and the third lens 25, and the second shielding portion 292 is located between the first lens 22 and the second lens 24. In one embodiment, the first shielding portion 291 and the second shielding portion 292 are SOMA sheets for shielding or absorbing stray light (including part of the first light that is not used for imaging). The first shielding portion 291 and the second shielding portion 292 are beneficial to prevent the stray light from influencing an imaging quality.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a lens barrel comprising a first end and a second end, a receiving space being provided between the first end and the second end, wherein the first end comprises a light inlet opening communicating with the receiving space, the second end comprises a light outlet opening communicating with the receiving space, a first light entering through the light inlet opening, and a second light exiting through the light outlet opening;
a first lens in the receiving space and configured to receive and transmit at least a portion of the first light; and
an aperture in the receiving space and fixedly arranged on a side of the first lens facing away from the second end, the aperture being configured to adjust an amount of the first light incident into the lens barrel.

2. The optical lens of claim 1 further comprising:
adhesive fixes the aperture on a surface of the first lens facing away from the second end.

3. The optical lens of claim 2, further comprising:
a groove defined on the surface of the first lens, wherein the adhesive fills the groove.

4. The optical lens of claim 3, wherein:
the groove is an annular groove.

5. The optical lens of claim 3 further comprising:
a bonding area defined on the first lens, wherein the bonding area is directly bonded to the aperture, the bonding area has a flat surface; and the groove is in the bonding area.

6. The optical lens of claim 1, wherein:
the first lens comprises a light transmission area and a flange area;
the flange area is arranged around the light transmission area;
the light transmission area is configured for transmitting the first light;
the flange area is fixed on the lens barrel; and
the aperture is fixedly arranged in the flange area of the first lens.

7. The optical lens of claim 1, wherein:
the first end of the lens barrel comprises a carrying portion;
the carrying portion extends from the first end of the lens barrel to the light inlet opening;
the carrying portion is located on a side of the aperture facing away from the first lens and configured for supporting the aperture.

8. The optical lens of claim 1, wherein:
the aperture is annular;
the light inlet opening is an annular opening; and
an inner diameter of the aperture is less than or equal to a diameter of the light inlet opening.

9. The optical lens of claim 8, wherein:
an imaginary line between a center of the aperture and a center of the first lens is perpendicular to an imaginary plane in which the aperture is located.

10. The optical lens of claim 1, further comprising a second lens and a third lens, wherein
the second lens and the third lens are located in the receiving space; and
the first lens, the second lens, and the third lens are sequentially arranged in the receiving space along a direction from the first end to the second end.

11. An electronic device comprising:
a display panel; and
an optical lens coupled to the display panel, the optical lens comprising:
a lens barrel provided with a first end and a second end, a receiving space provided between the first end and the second end, the first end provided with a light inlet opening communicating with the receiving space, the second end provided with a light outlet opening communicating with the receiving space, a first light entering through the light inlet opening, and a second light exiting through the light outlet opening;
a first lens located in the receiving space and configured to receive and transmit at least a portion of the first light; and
an aperture located in the receiving space and fixedly arranged on a side of the first lens facing away from the second end, the aperture used to adjust an amount of the first light incident into the lens barrel; wherein:
the display panel displays images according to the second light.

12. The electronic device of claim 11, wherein:
an adhesive fixes the aperture on a surface of the first lens facing away from the second end.

13. The electronic device of claim 12, wherein:
the surface of the first lens is provided with a groove; and
the adhesive is filled in the groove.

14. The electronic device of claim 13, wherein:
the groove is an annular groove.

15. The electronic device of claim 13, wherein:
the first lens comprises a bonding area directly bonded to the aperture;
the bonding area has a flat surface; and
the groove is located at the bonding area.

16. The electronic device of claim 11, wherein:
the first lens comprises a light transmission area and a flange area;
the flange area is arranged around the light transmission area;
the light transmission area is used for transmitting the first light;
the flange area is fixed on the lens barrel; and
the aperture is fixedly arranged in the flange area of the first lens.

17. The electronic device of claim 11, wherein:
the first end of the lens barrel comprises a carrying portion;
the carrying portion extends from the first end of the lens barrel to the light inlet opening;
the carrying portion is located on a side of the aperture facing away from the first lens and used for supporting the aperture.

18. The electronic device of claim 11, wherein:
the aperture is annular;
the light inlet opening is an annular opening; and
an inner diameter of the aperture is less than or equal to a diameter of the light inlet opening.

19. The electronic device of claim 18, wherein:
a line between a center of the aperture and a center of the first lens is perpendicular to a plane in which the aperture is located.

20. The electronic device of claim 11, further comprising a second lens and a third lens;
the second lens and the third lens are located in the receiving space; and
the first lens, the second lens, and the third lens are sequentially arranged in the receiving space along a direction from the first end to the second end.
